(19) United States
(12) Patent Application Publication
(10) Pub. No.: US 2010/0009137 A1
(43) Pub. Date: Jan. 14, 2010

(54) COMPOSITION FOR IMPRINTS, PATTERN AND PATTERNING METHOD

(75) Inventor: Kunihiko KODAMA, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/498,397

(22) Filed: Jul. 7, 2009

(30) Foreign Application Priority Data
Jul. 9, 2008 (JP) 2008-178946

(51) Int. Cl. C08K 5/10; B28B 7/38; C08K 5/00; C08K 5/5415; B29C 59/02; B32B 3/10

(52) U.S. Cl. 428/195.1; 106/38.22; 106/38.24; 524/81; 524/284; 524/315; 524/306; 524/317; 524/261; 524/556; 524/577; 524/570; 264/293

(57) ABSTRACT

A lubricant-containing composition for imprints comprising a polymerizable monomer and a photopolymerization initiator in combination or a resin component is excellent in patternability and mold releasability. The composition can form a pattern having a small line edge roughness after etching.

### BACKGROUND OF THE INVENTION

1. Field of the Invention

The present invention relates to a composition for imprints. More precisely, the invention relates to a composition for micropatterning to give imprints, which is used in producing magnetic recording media such as semiconductor integrated circuits, flat screens, microelectromechanical systems (MEMS), sensor devices, optical discs, high-density memory discs, etc.; optical members such as gratings, relief holograms, etc.; optical films for production of nanodevices, optical devices, flat panel displays, etc.; polarizing elements, thin-film transistors in liquid-crystal displays, organic transistors, color filters, overcoat layers, pillar materials, rib materials for liquid-crystal alignment, microlens arrays, immunoassay chips, DNA separation chips, microreactors, nanobio devices, optical waveguides, optical filters, photonic liquid crystals, etc.

2. Description of the Related Art

Imprint technology is a development advanced from embossing technology well known in the art of optical disc production, which comprises pressing a mold original with an embossed pattern formed on its surface (this is generally referred to as “mold”, “stamper” or “template”) against a resin to thereby accurately transfer the micropattern onto the resin through mechanical deformation of the resin. In this, when a mold is once prepared, then microstructures such as nanostructures can be repeatedly molded, and therefore, this is economical, and in addition, harmful wastes and discharges from this nanotechnology are reduced. Accordingly these days, this is expected to be applicable to various technical fields.

Two methods of imprint technology have been proposed; one is a thermal imprint method using a thermoplastic resin as the material to be worked (for example, see S. Chou, et al., Appl. Phys. Lett. Vol. 67, 3114 (1995)), and the other is a photoimprint method using a photocurable composition (for example, see M. Colbun, et al., Proc. SPIE, Vol. 3676, 379 (1999)). In the thermal imprint method, a mold is pressed against a polymer resin heated up to a temperature not lower than the glass transition temperature thereof, then the resin is cooled and thereafter released from the mold to thereby transfer the microstructure of the mold onto the resin on a substrate. The method is applicable to various resin materials and glass materials and is expected to be applicable to various fields. For example, U.S. Pat. Nos. 5,772,905 and 5,956,216 disclose a imprint method of forming nanopatterns inexpensively.

On the other hand, in the photoimprint method where a composition for photoimprints is photocured by photoirradiation through a transparent mold or a transparent substrate, the transferring material does not require heating in pressing it against the mold, and therefore the method enables room-temperature imprinting. Recently, new developments having the advantages of the above two as combined, have been reported, including a nanocasting method and a reversal imprint method for forming three-dimensional structures.

For the imprint methods as above, proposed are applied technologies to nano-scale mentioned below.

In the first technology, the molded pattern itself has a function, and is applied to various elements in nanotechnology and to structural members. Its examples include various micro/nano optical elements and high-density recording media, as well as structural members in optical films, flat panel displays, etc. The second technology is for hybrid-molding of microstructures and nanostructures, or for construction of laminate structures through simple interlayer positioning, and this is applied to production of μ-TAS (micro-total analysis system) and biochips. In the third technology, the formed pattern is used as a mask and is applied to a method of processing a substrate through etching or the like. In these technologies, high-precision positioning is combined with high-density integration; and in place of conventional lithography technology, these technologies are being applied to production of high-density semiconductor integrated circuits and transistors in liquid-crystal displays, and also to magnetic processing for next-generation hard discs referred to as patterned media. Recently, the action on industrialization of the above-mentioned imprint technologies and their applied technologies has become active for practical use thereof.

As one example of imprint technology, hereinunder described is an application to production of high-density semiconductor integrated circuits. The recent development in micropatterning and integration scale enlargement in semiconductor integrated circuits is remarkable, and high-definition photolithography for pattern transfer for realizing the intended micropatterning is being much promoted and advanced in the art. However, for further requirement for more definite micropatterning to a higher level, it is now difficult to satisfy all the three of micropattern resolution, cost reduction and throughput increase. Regarding this, as a technology of micropatterning capable of attaining at a low cost, imprint lithography, particularly nanoimprint lithography is proposed. For example, U.S. Pat. Nos. 5,772,905 and 5,259,926 disclose a nanoimprint technology of using a silicon wafer as a stamper for transferring a microstructure of at most 25 nm. This application requires micropatternability on a level of a few tens nm and high-level etching resistance of the micropattern functioning as a mask in substrate processing.

An application example of imprint technology to production of next-generation hard disc drives (HDD) is described. Based on head performance improvement and media performance improvement closely connected with each other, the course of HDD history is for capacity increase and size reduction. From the viewpoint of media performance improvement, HDD has realized increased large-scale capacity as a result of the increase in the surface-recording density thereon. However, in increasing the recording density, there occurs a problem of so-called magnetic field expansion from the side surface of the magnetic head. The magnetic field expansion could not be reduced more than a certain level even though the size of the head is reduced, therefore causing a phenomenon of so-called sidelight. The sidelight, if any, causes erroneous writing on the adjacent tracks and may erase the already recorded data. In addition, owing to the magnetic field expansion, there may occur another problem in that superfluous signals may be read from the adjacent track in reproduction. To solve these problems, there are proposed technologies of discrete track media and bit patterned media of filling the distance between the adjacent tracks with a non-magnetic material to thereby physically and magnetically separate the tracks. As a method of forming the magnetic or non-magnetic pattern in production of these media, application of imprint technology is proposed. The application also requires micropatternability on a level of a few tens nm and high-level etching resistance of the micropattern functioning as a mask in substrate processing.

Next described is an application example of imprint technology to flat displays such as liquid-crystal displays (LCD) and plasma display panels (PDP).

With the recent tendency toward large-sized LCD substrates and PDP substrates for high-definition microprocessing thereon, photoimprint lithography has become specifically noted these days as an inexpensive lithography technology capable of being substituted for conventional photolithography for use in production of thin-film transistors (TFT) and electrode plates. Accordingly, it has become necessary to develop a photocurable resist capable of being substituted for the etching photoresist for use in conventional photolithography.

Further, for the structural members for LCD and others, application of photoimprint technology to transparent protective film materials described in JP-A-2005-197699 and 2005-301289, or to spacers described in JP-A-2005-301289 is being under investigation. Differing from the above-mentioned etching resist, the resist for such structural members finally remains in displays, and therefore, it may be referred to as “permanent resist” or “permanent film”.

The spacer to define the cell gap in liquid-crystal displays is also a type of the permanent film; and in conventional photolithography, a photocurable composition comprising a resin, a photopolymerizable monomer and an initiator has been generally widely used for it (for example, see JP-A-2004-240241). In general, the spacer is formed as follows: After a color filter is formed on a color filter substrate, or after a protective film for the color filter is formed, a photocurable composition is applied thereto, and a pattern having a size of from 10 μm or 20 μm or so is formed through photolithography, and this is further thermally cured through past-baking to form the intended spacer.

Further, imprint lithography is useful also in formation of permanent films in optical members such as microelectromechanical systems (MEMS), sensor devices, gratings, relief holograms, etc.; optical films for production of nanodevices, optical devices, flat panel displays, etc.; polarizing elements, thin-film transistors in liquid-crystal displays, organic transistors, color filters, overcoat layers, pillar materials, rib materials for liquid-crystal alignment, microlens arrays, immunoassay chips, DNA separation chips, microreactors, nanobio devices, optical waveguides, optical filters, photonic liquid crystals, etc.

In application to such permanent films, the formed pattern remains in the final products, and is therefore required to have high-level properties of mainly film durability and strength, including heat resistance, light resistance, solvent resistance, scratch resistance, high-level mechanical resistance to external pressure, hardness, etc.

Almost all patterns heretofore formed in conventional photolithography can be formed in imprint technology, which is therefore specifically noted as a technology capable of forming micropatterns inexpensively.

It is an assumption that these applications form a good pattern, however, with regard to the photoimprint method in the patterning, it is necessary for the composition to be sufficiently charged in a mold, and the liquid curable composition for use in the photoimprint method is required to have a low viscosity. On the other hand, in the thermal imprint method, a mold is pressed against the resin composition softened by high-pressure heating to charge the resin composition into the mold. At this time, the thermal flowability of the resin composition has an effect. Further, in addition to the factors above, various factors such as the friction between the mold and the composition, the affinity of the composition with the mold, the mold-pressing pressure, and the like affect the patternability, and accordingly, a clear guideline for forming a good pattern is not available at present.

Another important parameter in imprint technology for micropatterning is the peelability of the composition for imprints from molds. Different from photolithography in which a photosensitive composition is not kept in contact with a mask, a composition for imprints is kept in contact with the mold in imprint technology. In peeling from the mold, when the residue of the composition remains on the mold, there occurs a problem in that the residue may form pattern failures in the subsequent imprinting procedure. For solving the problem, some trials have heretofore been taken for mold surface treatment. Concretely, a method of bonding a fluoroalkyl chain-containing silane coupling agent to a mold surface, or a method of using a fluorine/plasma-processed mold or a fluorine-containing resin mold has been tried for solving the residue deposition problem. However, in industrial-scale mass production, the mold to be used is required to be resistant to tens of thousands of times of imprinting repetition; and not only the mold surface treatment but also the mold releasability improvement of the compositions for imprints is required.

Furthermore, in patterning by the photolithography method, the space part of the obtained pattern allows the substrate to be exposed, whereas in patterning by the imprint method, in principle, the composition remains between the mold projections and the substrate, and thus, a residual film is generated in the obtained pattern space part. There also occurred a problem that if etching is performed in removing the residual film, unevenness (line edge roughness) on the side wall of the pattern is exacerbated.

As such, in industrial use of the imprint method, a good pattern substantially complementary to the mold is required to be formed (patternability), the composition is required to not be adhered to the mold (mold releasability), and the characteristics such as the etching resistance, the etching uniformity, and the membrane strength are required according to the applications, and as a result, it is important to satisfy all of these requirements at the same time. In particular, recently, from a desire to form a fine pattern of 100 nm or less, there has been a demand for composition for imprints, which has improved in mold releasability, pattern shape and line edge roughness at the same time.

### SUMMARY OF THE INVENTION

It is an object of the invention to provide a composition for imprints, which is excellent in patternability and mold releasability and which is thus capable of forming a good pattern, and which has a small line edge roughness in the pattern obtained after etching, and to provide a pattern and patterning method using the same.

Taking these problems into consideration, the present inventors have made extensive studies, and as a result, they have found that these problems can be solved at the same time by adding a lubricant. The present inventors thus provide a composition for imprints of the invention, which comprises (1) a lubricant as an essential component and (2-1) a polymerizable monomer and a photopolymerization initiator in combination or (2-2) a resin component. Specifically, the constitutions of the invention are as follows.
[1] A composition for imprints, which comprises a polymerizable monomer (A), a photopolymerization initiator (B), and a lubricant (C).
[2] The composition for imprints as described in [1], wherein the polymerizable monomer (A) comprises a (meth)acrylate compound having an aromatic ring.
[3] The composition for imprints as described in [1] or [2], wherein in the polymerizable monomer (A), the content of polymerizable monomers having at least one of an urethane group, a hydroxyl group and an amide group is 20% by mass or less, relative to all the polymerizable monomers contained in the composition.
[4] A composition for imprints, which comprises a resin component (D) and a lubricant (C).
[5] The composition for imprints as described in any one of [1] to [4], wherein the lubricant (C) has at least one structure of an alkyl chain structure having 4 or more carbon atoms, an aralkyl structure and an ester structure.
[6] The composition for imprints as described in any one of [1] to [5], wherein the lubricant (C) is a fatty acid ester, a fatty acid diester, a polyol ester or a silicone oil modified with at least one of an alkyl group, an aralkyl group and an ester group.
[7] The composition for imprints as described in any one of [1] to [6], which further comprises a solvent (E).
[8] The composition for imprints as described in [7], wherein the solvent (E) comprises a solvent having at least one functional group selected from the group consisting of an ester group, an ether group, a ketone group and a hydroxyl group.
[9] The composition for imprints as described in any one of [1] to [8], which further comprises a nonionic surfactant.
[10] A patterning method comprising providing the composition for imprints as described in any one of [1] to [9] onto a substrate to form a patterning layer thereon, and pressing a mold against the surface of the patterning layer.
[11] A pattern obtained by the patterning method of [10].

According to the present invention, a composition for imprints, which is excellent in patternability and mold releasability and thus capable of forming a good pattern, and which has a small line edge roughness in the pattern obtained after etching, can be provided.

### BEST MODE FOR CARRYING OUT THE INVENTION

The contents of the invention are described in detail hereinunder. In this specification, the numerical range expressed by the wording “a number to another number” means the range that falls between the former number indicating the lowermost limit of the range and the latter number indicating the uppermost limit thereof. In this specification, mass ratio is equal to weight ratio.

In this specification, “(meth)acrylate” means acrylate and methacrylate; “(meth)acrylic” means acrylic and methacrylic; “(meth)acryloyl” means acryloyl and methacryloyl. In the invention, monomer is differentiated from oligomer and polymer, and the monomer indicates a compound having a weight-average molecular weight of at most 1,000. In this specification, “functional group” means a group participating in polymerization. “Imprint” referred to in the invention is meant to indicate pattern transfer in a size of from 1 nm to 10 mm and preferably meant to indicate pattern transfer in a size of from about 10 nm to 100 μm (nanoimprint).

Regarding the expression of “group (atomic group)” in this specification, the expression with no indication of “substituted” or “unsubstituted” includes both “substituted group” and “unsubstituted group”. For example, “alkyl group” includes not only an alkyl group not having a substituent (unsubstituted alkyl group) but also an alkyl group having a substituent (substituted alkyl group).

### COMPOSITION FOR IMPRINTS OF THE INVENTION

### First Embodiment of the Invention

A first embodiment in the composition for imprints of the invention (which may be hereinafter referred to as the “composition of the invention”) is a curable composition for photoimprints, which comprises a polymerizable monomer (A), a photopolymerization initiator (B), and a lubricant (C) (which may be hereinafter referred to as “composition for photoimprints” of the invention). Generally, the curable composition used in the photoimprint method has been constituted by comprising a polymerizable monomer having a polymerizable functional group, and a photopolymerization initiator that initiates the polymerization reaction of the polymerizable monomer through photoirradiation, and also optionally comprising a solvent, a surfactant, an antioxidant, or the like. In the invention, it further comprises a lubricant (C).

### Polymerizable Monomer (A)

The polymerizable monomers which can be preferably used in the invention include, for example, a polymerizable unsaturated monomer having from 1 to 6 ethylenic unsaturated bond-having groups, a compound having an oxirane ring (epoxy compound), a vinyl ether compound, a styrene derivative, a fluorine atom-having compound, propenyl ether, butenyl ether, etc. From the viewpoint of the curability of the composition, more preferred is a polymerizable unsaturated monomer having from 1 to 6 ethylenic unsaturated bond-having groups.

The polymerizable unsaturated monomer having from 1 to 6 ethylenic unsaturated bond-having groups (mono- to hexa-functional polymerizable unsaturated monomer) is described below.

The polymerizable unsaturated monomer having one ethylenic unsaturated bond-having group (mono-functional polymerizable unsaturated monomer) includes concretely 2-acryloyloxyethyl phthalate, 2-acryloyloxy-2-hydroxyethyl phthalate, 2-acryloyloxyethyl hexahydrophthalate, 2-acryloyloxypropyl phthalate, 2-ethyl-2-butylpropanediol acrylate, 2-ethylhexyl(meth)acrylate, 2-ethylhexylcarbitol(meth)acrylate, 2-hydroxybutyl(meth)acrylate, 2-hydroxyethyl(meth)acrylate, 2-hydroxypropyl(meth)acrylate, 2-methoxyethyl(meth)acrylate, 3-methoxybutyl(meth)acrylate, 4-hydroxybutyl(meth)acrylate, acrylic acid dimer, benzyl(meth)acrylate, 1- or 2-naphthyl(meth)acrylate, butanediol mono(meth)acrylate, butoxyethyl(meth)acrylate, butyl(meth)acrylate, cetyl(meth)acrylate, ethyleneoxide-modified (hereinafter this may be referred to as “EO”) cresol(meth)acrylate, dipropylene glycol(meth)acrylate, ethoxylated phenyl(meth)acrylate, ethyl(meth)acrylate, isoamyl(meth)acrylate, isobutyl(meth)acrylate, isooctyl(meth)acrylate, cyclohexyl(meth)acrylate, isobornyl(meth)acrylate, dicyclopentanyl(meth)acrylate, dicyclopentanyloxyethyl(meth)acrylate, isomyristyl(meth)acrylate, lauryl(meth)acrylate, methoxydiproylene glycol(meth)acrylate, methoxytripropylene glycol(meth)acrylate, methoxypolyethylene glycol(meth)acrylate, methoxytriethylene glycol(meth)acrylate, methyl(meth)acrylate, neopentyl glycol benzoate(meth)acrylate, nonylphenoxypolyethylene glycol(meth)acrylate, nonylphenoxypolypropylene glycol(meth)acrylate, octyl(meth)acrylate, paracumylphenoxyethylene glycol(meth)acrylate, epichlorohydrin (hereinafter referred to as “ECH”)-modified phenoxyacrylate, phenoxyethyl(meth)acrylate, phenoxydiethylene glycol(meth)acrylate, phenoxyhexaethylene glycol(meth)acrylate, phenoxytetraethylene glycol(meth)acrylate, polyethylene glycol(meth)acrylate, polyethylene glycol-polypropylene glycol(meth)acrylate, polypropylene glycol(meth)acrylate, stearyl(meth)acrylate, EO-modified succinic acid(meth)acrylate, tert-butyl(meth)acrylate, tribromophenyl(meth)acrylate, EO-modified tribromophenyl(meth)acrylate, tridodecyl(meth)acrylate, p-isopropenylphenol, styrene, α-methylstyrene, acrylonitrile.

Of those, in view of dry etching resistance, especially preferred are (meth)acrylates having an aromatic group or an acyclic hydrocarbon group. Preferred for use in the invention are benzyl(meth)acrylate, 1- or 2-naphthyl(meth)acrylate, 1- or 2-naphthylmethyl(meth)acrylate, dicyclopentanyl(meth)acrylate, dicyclopentanyloxyethyl(meth)acrylate, isobornyl(meth)acrylate, adamantyl(meth)acrylate. More preferred for use in the invention are (meth)acrylates having a naphthalene structure, which are excellent in line edge roughness after dry etching.

As the other polymerizable monomer, also preferred is a polyfunctional polymerizable unsaturated monomer having two or more ethylenic unsaturated bond-containing groups.

Preferred examples of the difunctional polymerizable unsaturated monomer having two ethylenic unsaturated bond-containing groups for use in the invention include diethylene glycol monoethyl ether(meth)acrylate, dimethylol-dicyclopentane di(meth)acrylate, di(meth)acrylated isocyanurate, 1,3-butylene glycol di(meth)acrylate, 1,4-butanediol di(meth)acrylate, EO-modified 1,6-hexanediol di(meth)acrylate, ECH-modified 1,6-hexanediol di(meth)acrylate, allyloxy-polyethylene glycol acrylate, 1,9-nonanediol di(meth)acrylate, EO-modified bisphenol A di(meth)acrylate, PO-modified bisphenol A di(meth)acrylate, modified bisphenol A di(meth)acrylate, EO-modified bisphenol F di(meth)acrylate, ECH-modified hexahydrophthalic acid diacrylate, hydroxypivalic acid neopentyl glycol di(meth)acrylate, neopentyl glycol di(meth)acrylate, EO-modified neopentyl glycol diacrylate, propyleneoxide (hereinafter referred to as “PO”)-modified neopentyl glycol diacrylate, caprolactone-modified hydroxypivalate neopentyl glycol, stearic acid-modified pentaerythritol di(meth)acrylate, ECH-modified phthalic acid di(meth)acrylate, poly(ethylene glycol-tetramethylene glycol) di(meth)acrylate, poly(propylene glycol-tetramethylene glycol) di(meth)acrylate, polyester (di)acrylate, polyethylene glycol di(meth)acrylate, polypropylene glycol di(meth)acrylate, ECH-modified propylene glycol di(meth)acrylate, silicone di(meth)acrylate, triethylene glycol di(meth)acrylate, tetraethylene glycol di(meth)acrylate, dimethyloltricyclodecane di(meth)acrylate, neopentyl glycol-modified trimethylolpropane di(meth)acrylate, tripropylene glycol di(meth)acrylate, EO-modified tripropylene glycol di(meth)acrylate, triglycerol di(meth)acrylate, dipropylene glycol di(meth)acrylate, divinylethylene-urea, divinylpropylene-urea.

Of those, especially preferred for use in the invention are neopentyl glycol di(meth)acrylate, 1,9-nonanediol di(meth)acrylate, tripropylene glycol di(meth)acrylate, tetraethylene glycol di(meth)acrylate, hydroxypivalate neopentyl glycol di(meth)acrylate, polyethylene glycol di(meth)acrylate, etc.

Examples of the polyfunctional polymerizable unsaturated monomer having at least three ethylenic unsaturated bond-having groups include ECH-modified glycerol tri(meth)acrylate, EO-modified glycerol tri(meth)acrylate, PO-modified glycerol tri(meth)acrylate, pentaerythritol triacrylate, EO-modified phosphoric acid triacrylate, trimethylolpropane tri(meth)acrylate, caprolactone-modified trimethylolpropane tri(meth)acrylate, EO-modified trimethylolpropane tri(meth)acrylate, PO-modified trimethylolpropane tri(meth)acrylate, tris(acryloxyethyl) isocyanurate, dipentaerythritol hexa(meth)acrylate, caprolactone-modified dipentaerythritol hexa(meth)acrylate, dipentaerythritol hydroxy-penta(meth)acrylate, alkyl-modified dipentaerythritol penta(meth)acrylate, dipentaerythritol poly(meth)acrylate, alkyl-modified dipentaerythritol tri(meth)acrylate, ditrimethylolpropane tetra(meth)acrylate, pentaerythritol ethoxy-tetra(meth)acrylate, pentaerythritol tetra(meth)acrylate, etc.

Of those, especially preferred for use in the invention are EO-modified glycerol tri(meth)acrylate, PO-modified glycerol tri(meth)acrylate, trimethylolpropane tri(meth)acrylate, EO-modified trimethylolpropane tri(meth)acrylate, PO-modified trimethylolpropane tri(meth)acrylate, dipentaerythritol hexa(meth)acrylate, pentaerythritol ethoxy-tetra(meth)acrylate, pentaerythritol tetra(meth)acrylate, etc.

The oxirane ring-having compound (epoxy compound) includes, for example, polyglycidyl esters of polybasic acids, polyglycidyl ethers of polyalcohols, polyglycidyl ethers of polyoxyalkylene glycols, polyglycidyl ethers of aromatic polyols, hydrogenated polyglycidyl ethers of aromatic polyols, urethane-polyepoxy compounds, epoxidated polybutadienes, etc. One or more of these compounds may be used either singly or as combined.

Examples of the oxirane ring-having compound (epoxy compound) preferred for use in the invention include bisphenol A diglycidyl ether, bisphenol F diglycidyl ether, bisphenol S diglycidyl ether, brominated bisphenol A diglycidyl ether, brominated bisphenol F diglycidyl ether, brominated bisphenol S diglycidyl ether, hydrogenated bisphenol A diglycidyl ether, hydrogenated bisphenol F diglycidyl ether, hydrogenated bisphenol S diglycidyl ether, 1,4-butanediol diglycidyl ether, 1,6-hexanediol diglycidyl ether, glycerin triglycidyl ether, trimethylolpropane triglycidyl ether, polyethylene glycol diglycidyl ether, polypropylene glycol diglycidyl ether; polyglycidyl ethers of polyether polyols produced by adding one or more alkylene oxides to aliphatic polyalcohol such as ethylene glycol, propylene glycol, glycerin or the like; diglycidyl esters of aliphatic long-chain dibasic acids; monoglycidyl ethers of aliphatic higher alcohols; monoglycidyl ethers of polyether alcohols produced by adding alkyleneoxide to phenol, cresol, butylphenol or the like; glycidyl esters of higher fatty acids, etc.

Of those, especially preferred are bisphenol A diglycidyl ether, bisphenol F diglycidyl ether, hydrogenated bisphenol A diglycidyl ether, hydrogenated bisphenol F diglycidyl ether, 1,4-butanediol diglycidyl ether, 1,6-hexanediol diglycidyl ether, glycerin triglycidyl ether, trimethylolpropane triglycidyl ether, neopentyl glycol diglycidyl ether, polyethylene glycol diglycidyl ether, polypropylene glycol diglycidyl ether.

Commercial products favorable for use herein as the glycidyl group-having compound are UVR-6216 (by Union Carbide), Glycidol, AOEX24, Cyclomer A200 (all by Daicel Chemical Industry), Epikote 828, Epikote 812, Epikote 1031, Epikote 872, Epikote CT508 (all by Yuka Shell), KRM-2400, KRM-2410, KRM-2408, KRM-2490, KRM-2720, KRM-2750 (all by Asahi Denka Kogyo), etc. One or more of these may be used either singly or as combined.

The production method for the oxirane ring-having compounds is not specifically defined. For example, the compounds may be produced with reference to publications of Lecture of Experimental Chemistry 20, 4th Ed., Organic Synthesis II, p. 213, ff. (Maruzen, 1992); The chemistry of heterocyclic compounds—Small Ring Heterocycles, Part 3, Oxiranes (edited by Alfred Hasfner, John & Wiley and Sons, An Interscience Publication, New York, 1985); Yoshimura, Adhesive, Vol. 29, No. 12, 32, 1985; Yoshimura, Adhesive, Vol. 30, No. 5, 42, 1986; Yoshimura, Adhesive, Vol. 30, No. 7, 42, 1986; JP-A-11-100378, Japanese Patents 2906245 and 2926262.

As the other polymerizable monomer for use in the invention, vinyl ether compounds may be in the composition.

Any known vinyl ether compounds are usable, including, for example, 2-ethylhexyl vinyl ether, butanediol 1,4-divinyl ether, diethylene glycol monovinyl ether, ethylene glycol divinyl ether, triethylene glycol divinyl ether, 1,2-propanediol divinyl ether, 1,3-propanediol divinyl ether, 1,3-butanediol divinyl ether, 1,4-butanediol divinyl ether, tetramethylene glycol divinyl ether, neopentyl glycol divinyl ether, trimethylolpropane trivinyl ether, trimethylolethane trivinyl ether, hexanediol divinyl ether, tetraethylene glycol divinyl ether, pentaerythritol divinyl ether, pentaerythritol trivinyl ether, pentaerythritol tetravinyl ether, sorbitol tetravinyl ether, sorbitol pentavinyl ether, ethylene glycol diethylene vinyl ether, triethylene glycol diethylene vinyl ether, ethylene glycol dipropylene vinyl ether, triethylene glycol diethylene vinyl ether, trimethylolpropane triethylene vinyl ether, trimethylolpropane diethylene vinyl ether, pentaerythritol diethylene vinyl ether, pentaerythritol triethylene vinyl ether, pentaerythritol tetraethylene vinyl ether, 1,1,1-tris[4-(2-vinyloxyethoxy)phenyl]ethane, bisphenol A divinyloxyethyl ether, etc.

These vinyl ether compounds can be produced, for example, according to the method described in Stephen. C. Lapin, Polymers Paint Colour Journal, 179 (4237), 321 (1988), concretely through reaction of a polyalcohol or a polyphenol with acetylene, or through reaction of a polyalcohol or a polyphenol with a halogenoalkyl vinyl ether. One or more of these compounds may be used either singly or as combined.

As the other polymerizable monomer for use in the invention, styrene derivatives may also be employed. The styrene derivatives include, for example, styrene, p-methylstyrene, p-methoxystyrene, β-methylstyrene, p-methyl-β-methylstyrene, α-methylstyrene, p-methoxy-β-methylstyrene, p-hydroxystyrene, etc.

For the purpose of enhancing the releasability from mold and the coatability of the composition, a fluorine atom-having compound may be incorporated into the composition. The compound includes, for example, trifluoromethyl(meth)acrylate, pentafluoroethyl(meth)acrylate, (perfluorobutyl)ethyl(meth)acrylate, perfluorobutyl-hydroxypropyl(meth)acrylate, (perfluorohexyl)ethyl(meth)acrylate, octafluoropentyl(meth)acrylate, perfluorooctylethyl(meth)acrylate, tetrafluoropropyl(meth)acrylate, etc.

As the other polymerizable monomer for use in the invention, propenyl ethers and butenyl ethers may also be employed. Preferred examples of the propenyl ethers and butenyl ethers include, for example, 1-dodecyl-1-propenyl ether, 1-dodecyl-1-butenyl ether, 1-butenoxymethyl-2-norbornene, 1,4-di(1-butenoxy)butane, 1,10-di(1-butenoxy)decane, 1,4-di(1-butenoxymethyl)cyclohexane, diethylene glycol di(1-butenyl) ether, 1,2,3-tri(1-butenoxy)propane, propenyl ether propylene carbonate, etc.

More desirably, the polymerizable monomer as described above is contained, for example, in a range of from 70 to 99.9% by mass, preferably from 80 to 99.5% by mass, and more preferably from 90 to 99.5% by mass, of the total composition except the solvent of the invention.

A monofunctional polymerizable monomer is generally used as a reactive diluent, and has an effect of lowering the viscosity of the composition for imprints of the invention, and it is preferably added in an amount of at least 15% by mass, more preferably from 20 to 80% by mass, even more preferably from 25 to 70% by mass, and particularly preferably from 30 to 60% by mass, relative to the total amount of the polymerizable monomers.

A monomer having two unsaturated bond-having groups (difunctional polymerizable unsaturated monomer) is added in an amount of preferably at most 90% by mass, more preferably at most 80% by mass, and particularly preferably at most 70% by mass, of all the polymerizable unsaturated monomers. The proportion of the monofunctional and difunctional polymerizable unsaturated monomers to be added is preferably from 10 to 100% by mass, more preferably from 30 to 95% by mass, and particularly preferably from 50 to 90% by mass, of all the polymerizable unsaturated monomers. The proportion of the polyfunctional polymerizable unsaturated monomer having three or more unsaturated bond-having groups is preferably at most 80% by mass, more preferably at most 60% by mass, and particularly preferably at most 40% by mass, of all the polymerizable unsaturated monomers. When the proportion of the polymerizable unsaturated monomer having three or more polymerizable unsaturated bond-having groups is at 80% by mass or less, the viscosity of the composition can be lowered, thereby it becoming preferable.

The polymerizable monomer in the invention preferably comprises a (meth)acrylate compound having an aromatic ring. As the (meth)acrylate compound having an aromatic ring, a polymerizable monomer having 1 to 3 polymerizable groups is preferred, and a polymerizable monomer having one polymerizable group is more preferred. By comprising the (meth)acrylate compound having an aromatic ring, the line edge roughness after etching is further improved.

Further, the total content of polymerizable monomers having at least one of a urethane group, a hydroxyl group and an amide group is preferably 20% by mass or less of all the polymerizable monomers contained in the composition for nanoimprints of the invention. When the polymerizable monomers having at least one of an urethane group, a hydroxyl group and an amide group is contained in an amount of 20% by mass or less, the patternability and the line edge roughness after etching become better. The total content of the polymerizable monomers having at least one of an urethane group, a hydroxyl group and an amide group is more preferably 10% by mass or less, and particularly preferably 5% by mass or less, of all the polymerizable monomers contained in the composition for nanoimprints of the invention.

### Photopolymerization Initiator (B)

The composition for imprints of the invention comprises a photopolymerization initiator. As the photopolymerization initiator in the invention, usable is any compound capable of generating an active radical for polymerization of the above-mentioned polymerizable monomer through photoirradiation. As the photopolymerization initiator, preferred are radical polymerization initiators. In the invention, two or more different types of photopolymerization initiators may be used, as combined.

The content of the photopolymerization initiator may be, for example, from 0.01 to 15% by mass of all the components constituting the composition except solvent, preferably from 0.1 to 12% by mass, more preferably from 0.2 to 7% by mass. In case where two or more different types of photopolymerization initiators are used, the total amount thereof falls within the above range.

When the content of the photopolymerization initiator is at least 0.01% by mass, then it is favorable since the sensitivity (rapid curability), the power of resolution, the line edge accuracy and the coating film strength of the composition tend to be better. On the other hand, when the content of the photopolymerization initiator is at most 15% by mass, it is also favorable since the light transmittance, the discoloration resistance and the handlability of the composition tend to be better. Heretofore, inkjet compositions and compositions for liquid-crystal display color filters containing dye and/or pigments have been variously investigated in point of the preferred amount of the photopolymerization initiator and/or the photoacid generator to be in the compositions; however, there is no report relating to the preferred amount of the photopolymerization initiator and/or the photoacid generator to be added to photocurable compositions for imprints. In this connection, in the systems containing dye and/or pigment, the dye and/or the pigment may act as a radical-trapping agent and may have some influence on the photopolymerization and the sensitivity of the compositions. Taking this into consideration, the amount of the photopolymerization initiator to be added to these applications is optimized. On the other hand, in the composition for imprints of the invention, dye and/or pigment are not indispensable ingredients, and the optimum range of the photopolymerization initiator in the composition may differ from that in the field of inkjet compositions and compositions for liquid-crystal display color filters.

As the radical photopolymerization initiator for use in the invention, preferred are acylphosphine oxide compounds and oxime ester compounds from the viewpoint of the curing sensitivity and the absorption characteristics of the composition. As the photopolymerization initiator, for example, commercial products may be used. Their examples are Irgacure® 2959 (1-[4-(2-hydroxyethoxy)phenyl]-2-hydroxy-2-methyl-1-propan-1-one), Irgacure® 184 (1-hydroxycyclohexyl phenyl ketone), Irgacure® 500 (1-hydroxycyclohexyl phenyl ketone, benzophenone), Irgacure® 651 (2,2-dimethoxy-1,2-diphenylethan-1-one), Irgacure® 369 (2-benzyl-2-dimethylamino-1-(4-morpholinophenyl)butanone-1), Irgacure® 907 (2-methyl-1[4-methylthiophenyl]-2-morpholinopropan-1-one), Irgacure® 819 (bis(2,4,6-trimethylbenzoyl)-phenylphosphine oxide), Irgacure® 1800 (bis(2,6-dimethoxybenzoyl)-2,4,4-trimethylpentylphosphine oxide, 1-hydroxycyclohexyl phenyl ketone), Irgacure® 1800 (bis(2,6-dimethoxybenzoyl)-2,4,4-trimethylpentylphosphine oxide, 2-hydroxy-2-methyl-1-phenyl-1-propan-1-one), Irgacure® OXE01 (1,2-octanedione, 1-[4-(phenylthio)phenyl]-2-(O-benzoyloxime)), Darocur® 1173 (2-hydroxy-2-methyl-1-phenyl-1-propan-1-one), Darocur® 1116, 1398, 1174 and 1020, CGI242 (ethanone, 1-[9-ethyl-6-(2-methylbenzoyl)-9H-carbazol-3-yl]-1-(O-acety loxime)), which are all available from Ciba; Lucirin TPO (2,4,6-trimethylbenzoyldiphenylphosphine oxide), Lucirin TPO-L (2,4,6-trimethylbenzoylphenylethoxyphosphine oxide) which are both available from BASF; Esacure 1001M (1-[4-benzoylphenylsulfanyl]phenyl)-2-methyl-2-(4-methylphe nylsulfonyl)propan-1-one available from Nihon SiberHegner; Adeka Optomer® N-1414 (carbazole/phenone compound), Adeka Optomer® N-1717 (acridine compound), Adeka Optomer® N-1606 (triazine compound), all available from Asahi Denka; Sanwa Chemical's TFE-triazine (2-[2-(furan-2-yl)vinyl]-4,6-bis(trichloromethyl)-1,3,5-triazine), Sanwa Chemical's TME-triazine (2-[2-(5-methylfuran-2-yl)vinyl]-4,6-bis(trichloromethyl)-1,3,5-triazine), Sanwa Chemical's MP-triazine (2-(4-methoxyphenyl)-4,6-bis(trichloromethyl)-1,3,5-triazine); Midori Chemical's TAZ-113 (2-[2-(3,4-dimethoxyphenyl)ethenyl]-4,6-bis(trichloromethyl)-1,3,5-triazine), Midori Chemical's TAZ-108 (2-(3,4-dimethoxyphenyl)-4,6-bis(trichloromethyl)-1,3,5-triazine; as well as benzophenone, 4,4′-bisdiethylaminobenzophenone, methyl-2-benzophenone, 4-benzoyl-4′-methyldiphenyl sulfide, 4-phenylbenzophenone, ethyl Michler's ketone, 2-chlorothioxanthone, 2-methylthioxanthone, 2-isopropylthioxanthone, 4-isopropylthioxanthone, 2,4-diethylthioxanthone, 1-chloro-4-propoxythioxanthone, 2-methylthioxanthone, thioxanthone ammonium salt, benzoin, 4,4′-dimethoxybenzoin, benzoin methyl ether, benzoin ethyl ether, benzoin isopropyl ether, benzoin isobutyl ether, benzyl dimethyl ketal, 1,1,1-trichloroacetophenone, diethoxyacetophenone, dibenzosuberone, methyl o-benzoylbenzoate, 2-benzoylnaphthalene, 4-benzoylbiphenyl, 4-benzoyldiphenyl ether, 1,4-benzoylbenzene, benzil, 10-butyl-2-chloroacridone, [4-(methylphenylthio)phenyl]phenylmethane), 2-ethylanthraquinone, 2,2-bis(2-chlorophenyl)-4,5,4′,5′-tetrakis(3,4,5-trimethoxy phenyl)-1,2′-biimidazole, 2,2-bis(o-chlorophenyl)-4,5,4′,5′-tetraphenyl-1,2′-biimidazole, tris(4-dimethylaminophenyl)methane, ethyl 4-(dimethylamino)benzoate, 2-(dimethylamino)ethyl benzoate, butoxyethyl 4-(dimethylamino)benzoate, etc.

In the invention, “light” includes not only those having with a wavelength falling within a range of ultraviolet, near-ultraviolet, far-ultraviolet, visible, infrared, and electromagnetic waves but also radiations. The radiations include, for example, microwaves, electron beams, EUV, X-rays. In addition, laser rays such as 248 nm excimer laser, 193 nm excimer laser, 172 nm excimer laser are also usable herein. These lights may be monochromatic lights (single wavelength lights) having passed through optical filters, or may be lights of different wavelengths (composite lights). For photoexposure, multiple photoexposure may be employable, and for the purpose of enhancing the film strength and the etching resistance of the composition, entire surface photoexposure may be effected after pattern formation.

The photopolymerization initiator in the invention must be suitably selected depending on the wavelength of the light source used; and preferred are those not generating gas during mold compression and photoexposure. Gas generation, if any, may cause mold contamination, therefore giving problems in that the mold must be washed frequently and the photocurable composition may be deformed in the mold and the transferred pattern accuracy may be thereby worsened.

The composition for imprints of the invention is preferably a radical-polymerizable composition, in which the polymerizable monomer (A) is a radical-polymerizable monomer and the photopolymerization initiator (B) is a radical polymerization initiator that generates a radical through photoirradiation.

### Lubricant (C)

The composition for imprints of the invention comprises a lubricant. The lubricant refers to a substance which reduces friction by application onto rotator parts of machines, or the like, thereby preventing the friction heat or the abrasion, and a number of compounds for this are commercially available. Further, examples of the lubricant include a liquid lubricant (also referred to as a lubricant oil), a semi-solid lubricant (grease), and a solid lubricant.

The lubricant used in the composition for imprints of the invention is not specifically defined, but a liquid lubricant is preferred in the invention. Specific examples of the liquid lubricant include animal or vegetable oils such as paraffinic mineral oil, naphthenic mineral oil, fatty acid glyceride, and the like; an olefinic lubricant having an alkyl structure, such as poly-1-decene, polybutene, and the like; an alkyl aromatic compound-based lubricant having an aralkyl structure; a polyalkylene glycol-based lubricant; an ether-based lubricant such as a polyalkylene glycol ether, a perfluoropolyether, polyphenyl ether, and the like; an ester-based lubricant having an ester structure, such as a fatty acid ester, a fatty acid diester, a polyol ester, a silicic acid ester, a phosphoric acid ester, and the like; a silicone-based lubricant such as tetraalkylsilane, non-modified silicone oil, alkyl modified silicone oil, alcohol modified silicone oil, polyether modified silicone oil, and the like; a fluorine atom-containing lubricant such as chlorofluorocarbon, and the like; etc., but these examples do not limit the lubricant of the invention. Further, these may be used singly or in combination of a plurality of kinds thereof.

Further, among these lubricants, a lubricant having at least one of an alkyl chain structure having 4 or more carbon atoms, an aralkyl structure, and an ester structure is preferred. The lubricant having at least one structure as described above is preferred since it is highly compatible with other compositions such as the polymerizable monomer as above, the solvent, and the like, and thus, the patternability and the line edge roughness after etching become better.

Specific examples of the lubricant having such a structure include an olefinic lubricant having an alkyl structure, an alkyl aromatic compound-based lubricant having an aralkyl structure, and an ester-based lubricant having an ester structure. Further, a modified silicone oil-based lubricant in which an alkyl chain structure having 4 or more carbon atoms, an aralkyl structure, and an ester structure constitute the partial structures of the modified silicone oil can also be mentioned.

### (Lubricant Having an Alkyl Chain Structure Having 4 or More Carbon Atoms)

The alkyl chain having 4 or more carbon atoms refers to an alkyl unit having 4 or more carbon atoms, not comprising a hetero atom, and it does not comprise a polyethyleneoxy chain or a polypropyleneoxy chain.

The alkyl chain structure having 4 or more carbon atoms is preferably an alkyl chain structure having 6 or more carbon atoms, and more preferably an alkyl chain structure having 8 or more carbon atoms. The alkyl chain structure may form an alkyl group end in the entire molecule of the lubricant, or may form an alkylene linking group. The alkyl chain structure may be any one of linear, branch, and cyclic structures, and linear and branch structures are preferred.

Examples of the lubricant having an alkyl chain structure having 4 or more carbon atoms include poly-α-olefins such as poly-1-decene, polybutene, and the like; alkyl modified silicone oil having 4 or more carbon atoms; and the like.

Specific examples of the poly-α-olefin include the following compounds of (a1) to (a3). In the following (a1), R¹ and R² each independently represent a hydrogen atom or an alkyl group. In the following (a1) to (a3), n represents an integer of 1 to 50. Further, these do not limit the lubricant used in the invention.

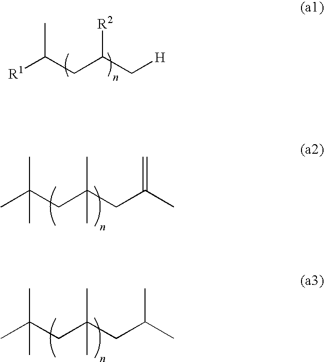

### (Lubricant Having an Aralkyl Structure)

The aralkyl structure means that an alkyl group is substituted with an aryl group, or an alkylene group is substituted with an aryl group. The number of carbon atoms of the alkyl group or the alkylene group in the aralkyl structure is not specifically defined, but the number of carbon atoms is preferably from 1 to 60, and more preferably from 2 to 30. Further, the alkyl group or the alkylene group may be any one of the linear, branch, and cyclic structures, but the linear and branch structures are preferable. The number of carbon atoms of the aryl group in the aralkyl structure is not specifically defined, but the number of carbon atoms is preferably from 6 to 10, and more preferably 6. Further, the position to be substituted with an aryl group in the aralkyl structure is not specifically defined, and any position of primary carbon, secondary carbon, and tertiary carbon of the alkyl group or the alkylene group may be substituted.

Examples of the lubricant having the aralkyl structure include an alkyl group structure substituted with a phenyl group, aralkyl modified silicone oil, and the like.

Specific examples of the lubricant based on an alkyl aromatic compound having an aralkyl structure include the following compounds of (a4) and (a5). In the following (a4) and (a5), n represents an integer of 1 to 50. Further, these do not limit the lubricant of the invention.

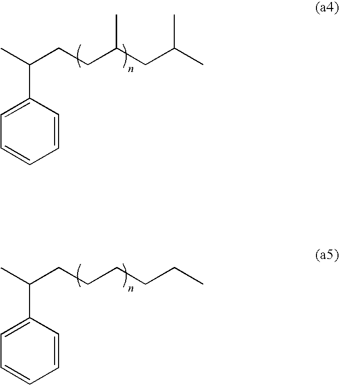

Examples of the alkyl chain modified silicone oil having 4 or more carbon atoms and the aralkyl modified silicone oil include the following silicone oil represented by (a6). Further, the alkyl and aralkyl modified silicone oils can also be preferably used as the lubricant of the invention. Furthermore, R³ represents an alkyl group having 4 or more carbon atoms, R⁴ represents an aralkyl group, R⁵ represents a polyether-containing group, x1 to x4 are each an integer of 0 or more, and x1+x2 represents an integer of 1 or more. Furthermore, these do not limit the lubricant of the invention.

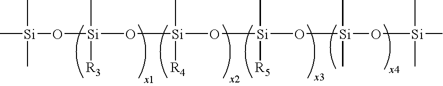

Examples of the alkyl and/or aralkyl modified silicone oil specifically include TSF4421, XF42-334, XF42-B3629, and XF42-A3161 manufactured by GE Toshiba Silicones Co., Ltd., BY16-846, SF8416, SH203, SH230, SF8419, and SF8422 manufactured by Dow Corning Corporation, KF-412, KF-413, KF-414, KF-415, KF-4003, KF-4701, KF-4917, KF-7235B, X-22-7322, X-22-1877, and X-22-2516 manufactured by Shin-Etsu Chemical Co., Ltd., and the like.

### (Lubricant Having an Ester Structure)

The lubricant having the ester structure is not specifically defined, but examples thereof include a fatty acid ester, a fatty acid diester, a polyol ester, a silicic acid ester, a polyester having a polyalkylene glycol structure in the molecule, a higher fatty acid ester modified silicone oil, and the like.

Examples of the fatty acid ester preferably include 2-ethylhexyl palmitate and isostearyl stearate.

Examples of the fatty acid diester preferably include di-2-ethylhexyl adipate, diisodecyl adipate, diisononyl adipate, di-2-ethylhexyl azelate, and 2-ethyl hexyl sebacate.

Examples of the polyol ester preferably include neopentyl glycol di-2-ethylhexanoic acid ester, trimethylol propane tricaprylic acid ester, trimethylol propane trioleic acid ester, ester of pentaerythritol with isooctylic acid, caprylic acid, oleic acid, or adipic acid, which may be single or combined.

Examples of the silicic acid ester preferably include tetradecyl silicate, tetraoctyl silicate, and a poly-sec-butyl silicate ester (Silicate Cluster 102 (manufactured by Olin Corporation)).

Examples of the polyester having a polyalkylene glycol structure in the molecule preferably include a polyethylene glycol diester (preferably a higher fatty acid ester), and a polypropylene glycol diester (preferably a higher fatty acid ester).

Examples of the higher fatty acid ester modified silicone oil include TSF410 and TSF411 manufactured by GE Toshiba Silicones Co., Ltd., KF-910 and X-22-715 manufactured by Shin-Etsu Chemical Co., Ltd., and the like.

The lubricant having the ester structure is preferably one having an alkyl structure having 4 or more carbon atoms and/or an aralkyl structure at the same time. In particular, the ester silicone oil may be alkyl and/or aralkyl and ester modified silicone oil.

The lubricant is more preferably, among these, a fatty acid ester, a fatty acid diester, a polyol ester, alkyl and/or aralkyl and/or ester modified silicone oil.

The content of the lubricant is from 0.01 to 10% by mass, preferably from 0.1 to 5% by mass, and more preferably 0.1 to 3% by mass, relative to all the polymerizable monomers.

### Other Ingredients

In addition to the above-mentioned polymerizable monomer (A), the photopolymerization initiator (B) and lubricant (C), the composition for imprints of the invention may comprise any other ingredients such as surfactant, antioxidant, solvent, polymer and others for various purposes not detracting from the effect of the invention. Preferably, the composition for imprints of the invention comprise at least one selected from nonionic surfactants and antioxidants.

### —Surfactant—

Preferably, the composition for imprints of the invention comprises a surfactant. The content of the surfactant that may be in the composition may be, for example, from 0.001 to 5% by mass of the composition, preferably from 0.002 to 4% by mass, more preferably from 0.005 to 3% by mass. In case where two or more different types of surfactants are in the composition, the total amount thereof falls within the above range. When the surfactant content in the composition falls from 0.001 to 5% by mass, it is favorable from the viewpoint of the coating uniformity, therefore hardly worsening the mold transferability owing to excessive surfactant.

As the surfactant, preferred are nonionic surfactants. Preferably, the composition comprises at least one of a fluorine-containing surfactant, a silicone-type surfactant and a fluorine-containing silicone-type surfactant.

“Fluorine-containing silicone-type surfactant” as referred to herein means a surfactant satisfying both the requirement of a fluorine-containing surfactant and that of a silicone-type surfactant.

Using the surfactant of the type may solve the problem of coating failures such as striation and flaky pattern formation (drying unevenness of resist film) that may occur when the composition for imprints of the invention is applied onto substrates on which various films are formed, for example, onto silicon wafers in semiconductor production, or onto glass square substrates, chromium films, molybdenum films, molybdenum alloy films, tantalum films, tantalum alloy films, silicon nitride films, amorphous silicon films, tin oxide-doped indium oxide (ITO) films or tin oxide films in production of liquid-crystal devices. In addition, the surfactant is effective for enhancing the flowability of the composition of the invention in the cavity of a female mold, for enhancing the mold-resist releasability, for enhancing the resist adhesiveness to substrates, and for lowering the viscosity of the composition. In particular, when the above-mentioned surfactant is added to the composition for imprints of the invention, the coating uniformity of the composition can be greatly improved; and in coating with it using a spin coater or a slit scan coater, the composition ensures good coating aptitude irrespective of the size of the substrate to which it is applied.

Examples of the nonionic fluorine-containing surfactant usable in the invention include Fluorad FC-430, FC-431 (Sumitomo 3M's trade names); Surflon S-382 (Asahi Glass's trade name); Eftop EF-122A, 122B, 122C EF-121, EF-126, EF-127, MF-100 (Tochem Products' trade names); PF-636, PF-6320, PF-656, PF-6520 (Omnova Solution's trade names); Futagent FT250, FT251, DFX18 (Neos' trade names); Unidyne DS-401, DS-403, DS-451 (Daikin's trade names); Megafac 171, 172, 173, 178K, 178A, F780F (Dai-Nippon Ink's trade names).

Examples of the nonionic silicone-type surfactant include SI-10 series (Takemoto Yushi's trade name), Megafac Paintad 31 (Dai-Nippon Ink's trade name), KP-341 (Shin-Etsu Chemical's trade name).

Examples of the fluorine-containing silicone-type surfactant include X-70-090, X-70-091, X-70-092, X-70-093 (Shin-Etsu Chemical's trade names); Megafac R-08, XRB-4 (Dai-Nippon Ink's trade names).

### —Antioxidant—

Preferably, the composition for imprints of the invention comprises a known antioxidant. The content of the antioxidant to be in the composition is, for example, from 0.01 to 10% by mass of the total amount of the polymerizable monomers constituting the composition, preferably from 0.2 to 5% by mass. When two or more different types of antioxidants are in the composition, the total amount thereof falls within the above range.

The antioxidant is for preventing fading by heat or photoirradiation, and for preventing fading by various gases such as ozone, active hydrogen NOx, SOx (x is an integer), etc. Especially in the invention, the antioxidant added to the composition brings about the advantage that the cured film is prevented from being discolored and the film thickness is prevented from being reduced through decomposition. The antioxidant includes hydrazides, hindered amine-type antioxidants, nitrogen-containing heterocyclic mercapto compounds, thioether-type antioxidants, hindered phenol-type antioxidants, ascorbic acids, zinc sulfate, thiocyanates, thiourea derivatives, saccharides, nitrites, sulfites, thiosulfates, hydroxylamine derivatives, etc. Of those, preferred are hindered phenol-type antioxidants and thioether-type antioxidants from the viewpoint of their effect of preventing cured film discoloration and preventing film thickness reduction.

Commercial products of the antioxidant usable herein include Irganox 1010, 1035, 1076, 1222 (all by Ciba-Geigy); Antigene P, 3C, FR, Sumilizer S, Sumilizer GA80 (by Sumitomo Chemical); Adekastab AO70, AO80, AO503 (by Adeka), etc. These may be used either singly or as combined.

### —Polymerization Inhibitor—

Furthermore, the composition for imprints of the invention preferably comprises a polymerization inhibitor. The content of the polymerization inhibitor is from 0.001 to 1% by mass, more preferably from 0.005 to 0.5% by mass, and even more preferably from 0.008 to 0.05% by mass, relative to all the polymerizable monomers, and the change in the viscosities over time can be inhibited while maintaining a high curing sensitivity by blending the polymerization inhibitor in an appropriate amount.

In the composition for imprints of the invention, the viscosity at 25° C. of the components except the solvent is preferably from 1 to 100 mPa·s. It is more preferably from 5 to 50 mPa·s, and even more preferably from 7 to 30 mPa·s. By setting the viscosity in an appropriate range, the rectangularity of the pattern is improved, and the residual film can be inhibited to a low level.

### —Solvent—

A solvent may be used for the composition for imprints of the invention, in accordance with various needs. In particular, when a pattern having a thickness of at most 500 nm is formed, the composition preferably comprises a solvent. Preferably, the solvent has a boiling point at normal pressure of from 70 to 200° C. Regarding the type of the solvent, any solvent capable of dissolving the composition may be used.

Examples of the solvents include solvents having an ester structure, an ketone structure, a hydroxyl group, an ether structure. Preferred among them are solvents having at least any one of an ester structure, a ketone structure, a hydroxyl group and an ether structure in view of evenness of a coated thin layer. Concretely, the solvent is preferably one or more selected from propylene glycol monomethyl ether acetate, cyclohexanone, 2-heptanone, gamma-butyrolactone, propylene glycol monomethyl ether, ethyl lactate. Most preferred is a solvent containing propylene glycol monomethyl ether acetate as securing coating uniformity.

The content of the solvent in the composition of the invention may be suitably optimized depending on the viscosity of the constitutive ingredients except the solvent, the coatability of the composition and the intended thickness of the film to be formed. From the viewpoint of the coatability, the solvent content is preferably from 0 to 99% by mass of the composition, more preferably from 0 to 97% by mass. In forming a patter having a thickness of at most 500 nm, the solvent content is preferably from 50 to 99% by mass, more preferably from 70 to 97% by mass.

### —Oligomer and Polymer Ingredient—

The composition of the invention may comprise a polyfunctional oligomer having a larger molecular weight than that of the above-mentioned, other polyfunctional monomer within a range capable of attaining the object of the invention, for the purpose of further increasing the crosslinking density of the composition. Examples of the photoradical-polymerizable polyfunctional oligomer include various acrylate oligomers such as polyester acrylates, urethane acrylates, polyether acrylates, epoxy acrylates. The amount of the oligomer ingredient to be added to the composition maybe preferably from 0 to 30% by mass of the composition except the solvent therein, more preferably from 0 to 20% by mass, even more preferably from 0 to 10% by mass, most preferably from 0 to 5% by mass.

The composition for imprints of the invention may comprise any other polymer ingredient for the purpose of enhancing the dry etching resistance, the imprint aptitude and the curability of the composition. The polymer ingredient is preferably a polymer having a polymerizable functional group in the side chain thereof. The weight-average molecular weight of the polymer ingredient is preferably from 2000 to 100000, more preferably from 5000 to 50000, from the viewpoint of the miscibility of the polymer with the polymerizable monomers constituting the composition. The amount of the polymer ingredient to be added may be preferably from 0 to 30% by mass of the composition except the solvent therein, more preferably from 0 to 20% by mass, even more preferably from 0 to 10% by mass, most preferably at most 2% by mass. When the content of the polymer ingredient having a molecular weight of at least 2000 in the composition of the invention is at most 30% by mass of the composition except the solvent therein, then the patternability of the composition is bettered. From the viewpoint of the patternability of the composition, the resin content therein is preferably as small as possible, and except for the surfactant and other minor additives, preferably, the composition does not comprise any additional resin ingredient.

In addition to the above-mentioned ingredients, the composition for imprints of the invention may comprise, if desired, release agent, silane coupling agent, UV absorbent, light stabilizer, antiaging agent, plasticizer, adhesion promoter, thermal polymerization initiator, colorant, elastomer particles, photoacid enhancer, photobase generator, basic compound, flowability promoter, defoaming agent, dispersant, etc.

### Second Embodiment of the Invention

A second embodiment in the composition for imprints of the invention is a composition for thermal imprints, which comprises a resin component (D) and a lubricant (C) (which may be hereinafter referred to as the “composition for thermal imprints” of the invention). Generally, the composition used in the thermal imprint method is constituted by comprising a resin component, and also optionally comprising a solvent, a surfactant, an antioxidant, or the like. In the invention, it further comprises a lubricant (C).

### Resin Component (D)

As the resin component, any resin capable of transferring a pattern can be used, but it is preferably a resin having a repeating unit selected from a (meth)acrylate repeating unit, a styrene repeating unit, and a polyolefin repeating unit. Preferable repeating units derive from for example methyl(meth)acrylate, benzyl(meth)acrylate, naphthyl(meth)acrylate, naphthyl methyl(meth)acrylate, 1-adamantyl(meth)acrylate, styrene, norbornene, and the like, which may have a substituent. Examples of the substituent preferably include an alkyl group, an alkoxy group, an alkoxyc arbonyl group, a halogen atom, a cyano group, a hydroxyl group, an acyl group, and the like.

As the resin component, the resin comprising a repeating unit having an aromatic ring can improve the dry etching resistance, and further reduce the line edge roughness after etching.

### Lubricant (C)

The composition for imprints of the second embodiment of the invention comprises a lubricant. As the lubricant, those mentioned in the first embodiment can be preferably used. The preferable range of the addition amounts thereof is the same as in the first embodiment.

### Solvent (E)

The composition for imprints of the second embodiment of the invention preferably further comprises a solvent. As the solvent, those mentioned in the first embodiment can be preferably used.

The composition for imprints of the second embodiment of the invention may comprise other components such as a surfactant, an antioxidant, and the like, within a range not interfering with the effect of the invention. The composition for imprints of the invention preferably comprises at least one selected from a nonionic surfactant, and an antioxidant. As the nonionic surfactant and the antioxidant, those mentioned in the first embodiment can be preferably used.

### (Process for Preparing the Composition for Imprints)

The composition for imprints of the invention is produced by mixing the above-mentioned ingredients. After the ingredients are mixed, the resulting mixture may be filtered through a filter having a pore size of from 0.003 μm to 5.0 μm to give a solution. The ingredients may be mixed and dissolved to prepare the composition, generally at a temperature falling within a range of from 0° C. to 100° C. The filtration may be effected in plural stages, or may be repeated plural times. The solution once filtered may be again filtered. Not specifically defined, the material of the filter maybe anyone, for example, polyethylene resin, polypropylene resin, fluororesin, nylon resin, etc.

### [Patterning Method]

Next, a method for forming a pattern (particularly, a micropattern) using the composition for imprints of the invention will be described. In the patterning method of the invention, for the thermal imprint method, a finer micropattern can be formed through a step of providing, preferably applying, more preferably coating the composition for imprints of the invention onto a substrate or a support (base) to form a patterning layer, a step of heating the patterning layer, a step of pressing a mold against the patterning layer, a step of cooling the patterning layer to which the mold has been pressed, and a step of releasing the mold.

Further, in the photoimprint method, a micropattern can be formed through a step of applying the composition for imprints of the invention onto a substrate to form a patterning layer, a step of pressing a mold against the surface of the patterning layer, a step of irradiating the patterning layer with light, and a step of releasing the mold.

Here, the composition for photoimprints of the invention may be cured by further heating after photoirradiation.

Hereinafter, the patterning method using the composition for imprints of the invention (pattern transferring method) will be specifically described.

In the patterning method of the invention, the composition of the invention is first applied onto the substrate to form a patterning layer.

The coating method for providing the composition for imprints of the invention onto a substrate may be a well known coating method of, for example, a dip coating method, an air knife coating method, a curtain coating method, a wire bar coating method, a gravure coating method, an extrusion coating method, a spin coating method, a slit scanning method, an inkjet method, etc. The thickness of the patterning method of the composition of the invention may vary depending on the use thereof, and may be from 30 nm to 30 μm or so. The composition of the invention may be applied in a mode of multilayer coating. Between the substrate and the patterning method of the composition of the invention, any other organic layer may be formed, such as a planarizing layer, etc. With that, the patterning layer is not kept in direct contact with the substrate, and therefore, the substrate may be prevented from being contaminated with dust or from being scratched. The pattern to be formed of the composition of the invention may have good adhesiveness to the organic layer, if any, formed on the substrate.

The substrate (base or support) to which the composition for imprints of the invention is applied may be selected from various materials depending on its use, including, for example, quartz, glass, optical film, ceramic material, vapor deposition film, magnetic film, reflective film, metal substrate of Ni, Cu, Cr, Fe or the like, paper, SOG (spin on glass), polymer substrate such as polyester film, polycarbonate film or polyimide film, TFT array substrate, PDP electrode plate, glass or transparent plastic substrate, electroconductive substrate of ITO, metal or the like, insulating substrate, semiconductor substrate such as silicon, silicon nitride, polysilicon, silicon oxide or amorphous silicon, which, however, are not limitative. The shape of the substrate is not also specifically defined. It may be tabular or roll. As described below, the substrate may be light-transmissive or non-light-transmissive, depending on the combination thereof with a mold.

Next, in the patterning method of the invention, a mold is pressed against the surface of the patterning layer in order to transfer the pattern onto the patterning layer. Further, in the thermal imprint method, a step of heating the patterning layer is performed. At this time, any one of a step of heating the patterning layer and a step of pressing the mold may be first performed, or both of the steps may be performed at the same time, but it is preferable to perform both of the steps from the viewpoint of productivity. By pressing the heating mold, the patterning layer may be heated. The heating temperature is Tg of the resin used or higher, and preferably a temperature higher than Tg by 20 to 100° C.

### (Mold)

The mold that can be used in the patterning method of the invention will be described.

As the mold that can be used in the invention, a mold having a transferable pattern formed thereon is used. The pattern on the mold may be formed, for example, through photolithography, electronic beam lithography, or the like according to the desired processing accuracy, but in the invention, the mold patterning method is not specifically defined.

### (Mold Material)

The mold material usable in the invention is described. In the photoimprint lithography with the composition of the invention, a light-transmissive material is selected for at least one of the mold material and/or the substrate. In the photoimprint lithography applied to the invention, the composition for imprints of the invention is applied onto a substrate to form a patterning layer thereon, and a light-transmissive mold is pressed against the surface of the layer, then this is irradiated with light from the back of the mold and the patterning layer is thereby cured. Alternatively, the composition for photoimprints is applied onto a light-transmissive substrate, then a mold is pressed against it, and this is irradiated with light from the back of the substrate whereby the composition for photoimprints can be cured.

Not specifically defined, the light-transmissive mold material for use in the photoimprints may be any one having a desired strength and durability. Concretely, its examples include glass, quartz, light-transparent resin such as PMMA or polycarbonate resin, transparent metal deposition film, flexible film of polydimethylsiloxane or the like, photocured film, metal film, etc.

The non-light-transmissive mold to be used in the invention is used is not also specifically defined and may be any one having a predetermined strength. Concretely, examples of the mold material include ceramic material, deposition film, magnetic film, reflective film, metal material of Ni, Cu, Cr, Fe or the like, as well as SiC, silicon, silicon nitride, polysilicon, silicon oxide, amorphous silicon, etc. However, these are not limitative. The shape of the mold is not also specifically defined, and may be any of a tabular mold or a roll mold. The roll mold is used especially when continuous transfer in patterning is desired.

The mold used in the patterning method of the invention may be subjected to release treatment for the purpose of further enhancing the releasability of the composition for imprint of the invention from the surface of the mold, and of further increasing the pattern productivity. Such a release treatment of the mold includes, for example, a treatment by a silicone-based, fluorine-based, or other type of silane coupling agent. Further, for example, commercial release agents such as Optool DSX manufactured by Daikin Industries, Ltd., Novec EGC-1720 manufactured by Sumitomo 3M Limited, and the like can be very suitably used for the release treatment of the mold. As such, by using a mold that has been subjected to release treatment, and using the composition for imprints of the invention, which has a high mold releasability, a higher imprint durability of the mold can be attained.

In case where the imprint lithography is performed using the composition of the invention, the patterning method of the invention is generally preferably performed at a mold pressure of 0.1 to 30 MPa. By setting the mold pressure at 30 MPa or less, the mold and the substrate become hard to deform and the patterning accuracy tends to increase. Furthermore, since the applied pressure is low, the device tends to be small-sized and thereby preferable. If the mold pressure is from 0.1 to 30 MPa, the residual film of the composition for imprints in the mold projections is reduced, and thus the uniformity in the mold transfer is ensured and thereby preferable. Further, in the case of the photoimprint method, the method is preferably performed at a mold pressure of 0.1 to 3 MPa, and in the case of the thermal imprint method, the method is preferably performed at a mold pressure of 5 to 30 MPa.

In the patterning method of the invention, the dose of photoirradiation in the step of irradiating the patterning layer with light may be sufficiently larger than the dose necessary for curing. The dose necessary for curing may be suitably determined depending on the degree of consumption of the unsaturated bonds in the composition for imprints and on the tackiness of the cured film as previously determined.

In the photoimprint lithography applied to the invention, the substrate temperature in photoirradiation may be room temperature; however, the photoirradiation may be attained under heat for enhancing the reactivity. In the previous stage of photoirradiation, preferably, the system is kept in vacuum as effective for preventing contamination with bubbles or contamination with oxygen or for preventing the reduction in reactivity, and as effective for enhancing the adhesiveness of the composition for imprints with mold. The system may be subjected to photoirradiation while still kept in vacuum. In the patterning method of the invention, the vacuum degree in photoirradiation is preferably from 10⁻¹ Pa to ordinary pressure.

Light to be used for photoirradiation to cure the composition for imprints of the invention is not specifically defined. For example, it includes light and irradiations with a wavelength falling within a range of high-energy ionizing radiation, near-ultraviolet, far-ultraviolet, visible, infrared, etc. The high-energy ionizing radiation source includes, for example, accelerators such as Cockcroft accelerator, Handegraf accelerator, linear accelerator, betatoron, cyclotron, etc. The electron beams accelerated by such an accelerator are used most conveniently and most economically; but also are any other radioisotopes and other radiations from nuclear reactors, such as γ rays, X rays, α rays, neutron beams, proton beams, etc. The UV sources include, for example, UV fluorescent lamp, low-pressure mercury lamp, high-pressure mercury lamp, ultra-high-pressure mercury lamp, xenon lamp, carbon arc lamp, solar lamp, etc. The radiations include microwaves, EUV, etc. In addition, laser rays for use in microprocessing of semiconductors, such as LED, semiconductor laser ray, 248 nm KrF excimer laser ray, 193 nm ArF excimer laser ray and others, are also favorably used in the invention. These lights may be monochromatic lights, or may also be lights of different wavelengths (mixed lights).

In photoexposure, the light intensity is preferably within a range of from 1 mW/cm² to 100 mW/cm². When the light intensity is at least 1 mW/cm², then the producibility may increase since the photoexposure time may be reduced; and when the light intensity is at most 100 mW/cm², then it is favorable since the properties of the permanent film formed may be prevented from being degraded owing to side reaction. Also preferably, the dose in photoexposure is within a range of from 5 mJ/cm² to 1000 mJ/cm². When the dose is less than 5 mJ/cm², then the photoexposure margin may be narrow and there may occur problems in that the photocuring may be insufficient and the unreacted matter may adhere to mold. On the other hand, when the dose is more than 1000 mJ/cm², then the composition may decompose and the permanent film formed may be degraded.

Further, in photoexposure, the oxygen concentration in the atmosphere may be controlled to be less than 100 mg/L by introducing an inert gas such as nitrogen or argon into the system for preventing the radical polymerization from being retarded by oxygen.

In the patterning method of the invention, after the pattern layer is cured through photoirradiation, if desired, the cured pattern may be further cured under heat given thereto. The method may additionally includes the post-curing step. Thermal curing of the composition of the invention after photoirradiation is preferably attained at 150 to 280° C., more preferably at 200 to 250° C. The heating time is preferably from 5 to 60 minutes, more preferably from 15 to 45 minutes.

### [Pattern]

The pattern formed according to the patterning method of the invention is useful as a permanent film, particularly as an etching resist. In case where the composition for imprints of the invention is used as an etching resist, a nano-order micropattern is first formed on a substrate such as a silicon wafer with a thin film of SiO₂ or the like formed thereon, according to the patterning method of the invention. Next, this is etched with hydrogen fluoride in wet etching, or with CF₄ in dry etching, thereby forming a desired pattern on the substrate. The composition for imprints of the invention exhibits especially good etching resistance in dry etching.

The pattern thus formed according to the patterning method of the invention as described in the above can be used as a permanent film (resist for structural members) for use in liquid-crystal displays (LCD) and others, or as an etching resist. After its production, the permanent film may be bottled in a container such as a gallon bottle or a coated bottle, and may be transported or stored. In this case, the container may be purged with an inert gas such as nitrogen, argon or the like for preventing the composition therein from being degraded. The composition may be transported or stored at ordinary temperature, but for preventing the permanent film from being degraded, it is preferably transported or stored at a controlled temperature of from −20° C. to 0° C. Needless-to-say, the composition is shielded from light to such a level on which its reaction does not go on.

### EXAMPLES

The characteristics of the invention are described more concretely with reference to Production Examples and Examples given below. In the following Examples, the material used, its amount and the ratio, the details of the treatment and the treatment process may be suitably modified or changed not overstepping the scope of the invention. Accordingly, the invention should not be limitatively interpreted by the Examples mentioned below.

### <Photoimprint Method>

### Examples 1 to 12

To the composition shown in Table 1 below were added a polymerization initiator P1 (2% by mass), a surfactant W1 (0.1% by mass), a lubricant (0.5% by mass relative to the polymerizable monomer) to prepare a photocurable composition of Example 1. Further, in the same manner as in Example 1, except that the lubricant was changed as in Table 1 below, the photocurable compositions of Examples 2 to 9 were prepared. The photocurable composition of Example 10 was prepared in the same manner as in Example 1, except that benzyl acrylate (containing an aromatic ring) of the polymerizable monomer R1 was changed into N-vinylpyrrolidone of R5. The photocurable composition of Example 11 was prepared in the same manner as in Example 6, except that trimethylol propane triacrylate of the polymerizable monomer R3 was changed into urethane acrylate (containing an urethane group) of R4. The photocurable composition of Example 12 was prepared in the same manner as in Example 5, except that benzyl acrylate of the polymerizable monomer R1 was changed into 1-naphthyl methyl acrylate of R6, the addition amount thereof was increased to 80% by mass, and the addition amounts of R2 and R3 were decreased to 10%.

### Comparative Examples 1 to 3

The composition of Comparative Example 1 was prepared in the same manner as in Example 1, except that a lubricant was not added. The composition of Comparative Example 2 was prepared in the same manner as in Example 10, except that a lubricant was not added. The composition of Comparative Example 3 was prepared in the same manner as in Example 11, except that a lubricant was not added.

TABLE 1

| | Polymerizable monomer (ratio: wt %) | | | Lubricant |
|---|---|---|---|---|
| Example 1 | R1 (60) | R2 (20) | R3 (20) | A |
| Example 2 | R1 (60) | R2 (20) | R3 (20) | B |
| Example 3 | R1 (60) | R2 (20) | R3 (20) | C |
| Example 4 | R1 (60) | R2 (20) | R3 (20) | D |
| Example 5 | R1 (60) | R2 (20) | R3 (20) | E |
| Example 6 | R1 (60) | R2 (20) | R3 (20) | F |
| Example 7 | R1 (60) | R2 (20) | R3 (20) | G |
| Example 8 | R1 (60) | R2 (20) | R3 (20) | H |
| Example 9 | R1 (60) | R2 (20) | R3 (20) | I |
| Example 10 | R5 (60) | R2 (20) | R3 (20) | A |
| Example 11 | R1 (60) | R2 (20) | R4 (20) | F |
| Example 12 | R6(80) | R2 (10) | R3 (10) | E |
| Comparative | R1 (60) | R2 (20) | R3 (20) | no |
| Example 1 | | | | |
| Comparative | R5 (60) | R2 (20) | R3 (20) | no |
| Example 2 | | | | |
| Comparative | R1 (60) | R2 (20) | R4 (20) | no |
| Example 3 | | | | |

(Polymerizable Monomer)
R1: benzyl acrylate (BISCOAT #160: manufactured by Osaka Organic Chemical Industry)
R2: neopentyl glycol diacrylate (KAYARAD NPGDA: manufactured by Nippon Kayaku)
R3: trimethylol propane triacrylate (ARONIX M-309: manufactured by Toa Gosei)
R4: urethane acrylate (GOHSELAC UV-7500 B: manufactured by Nippon Synthetic Chemical Industry)
R5: N-vinylpyrrolidone (manufactured by Aldrich Chemical)
R6: 1-naphthylmethyl acrylate (synthesized from 1-naphthol)
(Polymerization Initiator)
P1: 2,4,6-trimethylbenzoyl-ethoxyphenyl-phosphineoxide (Lucirin TPO-L: manufactured by BASF Corporation) (Surfactant)
W1: Megafac F780F (manufactured by DIC Corporation)
(Lubricant)
A: di-2-ethylhexyl sebacate
B: trimethylolpropane caprylic acid ester
C: pentaerythritol isooctylic acid ester
D: phosphoric acid tris(2-ethylhexyl) ester
E: long chain alkyl modified silicone oil KF-4001 (manufactured by Shin-Etsu Chemical)
F: higher fatty acid ester modified silicone oil TSF-410 (manufactured by GE Toshiba Silicones)
G: dimethyl silicone oil(KF-96-100 cs: manufactured by Shin-Etsu Chemical)
H: polyether modified silicone oil TSF4440 (manufactured by GE Toshiba Silicones)
I: alcohol modified silicone oil TSF4570 (manufactured by GE Toshiba Silicones)

### (Evaluation of Composition for Photoimprints)

Each of the compositions obtained by Examples 1 to 12 and Comparative Examples 1 to 3 was measured and evaluated in accordance with the following evaluation method. These results are shown in Table 2 below.

### <Mold Releasability>

Each of the compositions was applied onto a silicone substrate in a mode of spin coating to a film thickness of 200 nm. A mold of quartz having a rectangular line/space pattern (1/1) with a line width of 100 nm and a groove depth of 150 nm, of which the surface had been processed with fluorine, was put on the obtained coating film, and set in a imprinting device. The device was degassed in vacuum, and then nitrogen was introduced to the device by conducting the nitrogen purging. The mold was pressed against the substrate under a pressure of 1.5 atm at 25° C., and then this was exposed to light under a condition of 240 mJ/cm² from the back of the mold, and after the exposure, the mold was released to give a pattern. It was checked with a scanning electromicroscope or an optical microscope as to whether or not the composition component was adhered onto the mold used for patterning to evaluate the releasability.
A: Adherence of the composition onto the mold was not perceived at all.
B: Adherence of the composition onto the mold was perceived.

### <Patternability>

For the obtained pattern in the evaluation of the mold releasability, the pattern shape was observed using a scanning electromicroscope. When a rectangular pattern substantially complementary to the mold pattern is obtained, the patternability is good.
Rectangular: A rectangular pattern substantially complementary to the mold pattern was obtained.
RT: It was a round top shape having a roundish pattern top.

### <Line Edge Roughness>

The obtained substrate to which the pattern was adhered was subjected to dry etching with plasma of a gas of Ar/C₄F₈/O₂=100:4:2 using a dry etcher (U-621) manufactured by Hitachi High-Technology to remove the residual film. The length-direction edges of the line pattern of the obtained pattern in an area of 5 μm were examined with a length-measuring SEM (Hitachi, Ltd., S-8840) to measure the distance from the standard line where each edge was to be present. This measurement was made on 50 points, a standard deviation was determined, and 3 σ was calculated. A smaller value thereof indicates a better line edge roughness.

TABLE 2

| | Mold | | Line edge roughness |
|---|---|---|---|
| | Releasability | Patternability | (nm) |
| Example 1 | A | Rectangular | 5.4 |
| Example 2 | A | Rectangular | 5.3 |
| Example 3 | A | Rectangular | 5.3 |
| Example 4 | A | Rectangular | 5.2 |
| Example 5 | A | Rectangular | 5.3 |
| Example 6 | A | Rectangular | 5.4 |
| Example 7 | A | Rectangular | 7.2 |
| Example 8 | A | Rectangular | 6.8 |
| Example 9 | A | Rectangular | 6.9 |
| Example 10 | A | Rectangular | 6.1 |
| Example 11 | A | Rectangular | 6.2 |
| Example 12 | A | Rectangular | 4.7 |
| Comparative | B | RT | 7.0 |
| Example 1 | | | |
| Comparative | B | RT | 8.6 |
| Example 2 | | | |
| Comparative | B | RT | 8.3 |
| Example 3 | | | |

The composition of the invention is excellent in mold releasability and patternability, and further, the line edge roughness in the pattern after removing the residual film by dry etching was small, as compared with the composition of Comparative Examples. Furthermore, comparison between Example 1 and Example 10 confirmed that by using the polymerizable monomer comprising an aromatic ring, the line edge roughness was improved. Comparison between Example 6 and Example 11 confirmed that in Example 5, which did not comprise urethane acrylate, the line edge roughness was improved, as compared with the Example 11 which did comprise urethane acrylate. Comparison between Example 5 and Example 12 confirmed that in Example 12 in which a polymerizable monomer comprising a naphthalene structure was contained, the line edge roughness is better, as compared with Example 5. Furthermore, as compared with the non-modified silicone oil of Example 7, having an alkyl structure having less than 4 carbon atoms, the polyether modified silicone oil of Example 8 and the alcohol modified silicone oil of Example 9, the lubricant of Example 5, having an alkyl structure having 4 or more carbon atoms, and the modified silicone oil of Example 6, having an ester structure, provided further improved line edge roughness.

On the other hand, it could be confirmed that for the composition of Comparative Examples 1 to 3 in which a lubricant was not added, the mold releasability was deteriorated, thereby providing a round top shape having a roundish pattern top. Further, the line edge roughness was increased, from the comparison between Example 1 and Comparative Example 1, from the comparison between Example 10 and Comparative Example 2, or from the comparison between Example 11 and Comparative Example 3. That is, it was impossible to control the mold releasability, the pattern shape, and the line edge roughness in preferable ranges at the same time.

### <Thermal Imprint Method>

### Examples 13 to 16

The compounds shown in Table 3 below were mixed to prepare a thermal imprint composition of Example 13. Further, thermal imprint compositions of Examples 14 to 16 were prepared in the same manner as in Example 13, except that the lubricant was changed as shown in Table 3.

TABLE 3

| | Resin | Surfactant | Solvent | Lubricant |
|---|---|---|---|---|
| | (g) | (g) | (g) | (g) |
| Example 13 | P1 (1) | W1 (0.006) | S1 (19) | B (0.01) |
| Example 14 | P1 (1) | W1 (0.006) | S1 (19) | C (0.01) |
| Example 15 | P1 (1) | W1 (0.006) | S1 (19) | E (0.01) |
| Example 16 | P1 (1) | W1 (0.006) | S1 (19) | F (0.01) |
| Comparative | P1 (1) | W1 (0.006) | S1 (19) | no |
| Example 4 | | | | |

P1: polybenzyl methacrylate
W1: Megafac F780F (manufactured by DIC Corporation)
S1: propylene glycol monomethyl ether acetate

### Comparative Example 4

The thermal imprint composition of Comparative Example 4 was prepared in the same manner as in Example 13, except that a lubricant was not added.

### (Evaluation of Composition for Thermal Imprints)

Each of the compositions obtained by Examples 13 to 16 and Comparative Example 4 was measured and evaluated in accordance with the following evaluation method. These results are shown in Table 4 below.

### <Mold Releasability>

Each of the compositions was applied onto an Si wafer in a mode of spin coating, and then heated on a hot plate at 100° C. for 90 seconds to obtain a film having a film thickness of 300 nm. A silicone mold having a rectangular line/space pattern (1/1) with a line width of 100 nm and a groove depth of 150 nm, of which the surface had been processed with fluorine, was put thereon, and the mold was pressed at an applied pressure of 10 MPa under heating to 150° C. After cooling, the mold was released to give a pattern. It was checked with a scanning electromicroscope or an optical microscope as to whether or not the composition component was adhered onto the mold used for patterning, and the mold releasability was evaluated as follows.
A: Adherence of the composition onto the mold was not perceived at all.
B: Adherence of the composition onto the mold was perceived.

### <Patternability>

For the obtained pattern in the evaluation of the mold releasability, the pattern shape was observed using a scanning electromicroscope. When a rectangular pattern substantially complementary to the mold pattern is obtained, the patternability is good.
Rectangular: A rectangular pattern substantially complementary to the mold pattern was obtained.
RT: It was a round top shape having a roundish pattern top.

### <Line Edge Roughness>

The obtained substrate to which the pattern was adhered was subjected to dry etching with plasma of a gas of Ar/C₄F₈/O₂=100:4:2 using a dry etcher (U-621) manufactured by Hitachi High-Technology to remove the residual film. The length-direction edges of the line pattern of the obtained pattern in an area of 5 μm were examined with a length-measuring SEM (Hitachi, Ltd., S-8840) to measure the distance from the standard line where each edge was to be present. This measurement was made on 50 points, a standard deviation was determined, and 3 σ was calculated. A smaller value thereof indicates a better line edge roughness.

TABLE 4

| | | | Line edge |
|---|---|---|---|
| | Mold | | roughness |
| | Releasability | Patternability | (nm) |
| Example 13 | A | Rectangular | 5.4 |
| Example 14 | A | Rectangular | 5.3 |
| Example 15 | A | Rectangular | 5.3 |
| Example 16 | A | Rectangular | 5.2 |
| Comparative | A | RT | 6.3 |
| Example 4 | | | |

The composition of the invention was good in all of the mold releasability, the patternability, and the line edge roughness after etching even in the thermal imprint method.

On the other hand, the composition of Comparative Example 4 in which a lubricant was not added had a round top shape having a roundish pattern top, and also increased line edge roughness. That is, it was impossible to regulate the mold releasability, the pattern shape, and the line edge roughness in preferable ranges at the same time.

The present disclosure relates to the subject matter contained in Japanese Patent Application No. 178946/2008 filed on Jul. 9, 2008, which is expressly incorporated herein by reference in its entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A composition for imprints, which comprises:
a lubricant (C), and
a polymerizable monomer (A) and a photopolymerization initiator (B) in combination, or a resin component (D).

2. The composition for imprints according to claim 1 which comprises a polymerizable monomer (A), a photopolymerization initiator (B), and a lubricant (C).

3. The composition for imprints according to claim 2, wherein the polymerizable monomer (A) comprises a (meth)acrylate compound having an aromatic ring.

4. The composition for imprints according to claim 2, wherein the content of polymerizable monomers having at least one of an urethane group, a hydroxyl group and an amide group in the composition is 20% by mass or less, relative to all the polymerizable monomers contained in the composition.

5. The composition for imprints according to claim 2, wherein the lubricant (C) has at least one structure of an alkyl chain structure having 4 or more carbon atoms, an aralkyl structure and an ester structure.

6. The composition for imprints according to claim 2, wherein the lubricant (C) is a fatty acid ester, a fatty acid diester, a polyol ester, or a silicone oil modified with at least one of an alkyl group, an aralkyl group and an ester group.

7. The composition for imprints according to claim 2, which further comprises a solvent (E).

8. The composition for imprints according to claim 7, which comprises a solvent having at least one functional group selected from the group consisting of an ester group, an ether group, a ketone group and a hydroxyl group.

9. The composition for imprints according to claim 2, which further comprises a nonionic surfactant.

10. The composition for imprints according to claim 1, which comprises a resin component (D) and a lubricant (C).

11. The composition for imprints according to claim 10, wherein the lubricant (C) has at least one structure of an alkyl chain structure having 4 or more carbon atoms, an aralkyl structure and an ester structure.

12. The composition for imprints according to claim 10, wherein the lubricant (C) is a fatty acid ester, a fatty acid diester, a polyol ester, or a silicone oil modified with at least one of an alkyl group, an aralkyl group and an ester group.

13. The composition for imprints according to claim 10, which further comprises a solvent (E).

14. The composition for imprints according to claim 10, which comprises a solvent having at least one functional group selected from the group consisting of an ester group, an ether group, a ketone group and a hydroxyl group.

15. The composition for imprints according to claim 10, which further comprises a nonionic surfactant.

16. The composition for imprints according to claim 10, wherein the resin component (D) has at least one repeating unit selected from the group consisting of (meth)acrylate repeating units, styrene repeating units and polyolefin repeating units.

17. A patterning method, comprising providing a composition for imprints onto a substrate to form a patterning layer thereon, and pressing a mold against a surface of the patterning layer,
wherein the composition for imprints comprises:
a lubricant (C), and
a polymerizable monomer (A) and a photopolymerization initiator (B) in combination, or a resin component (D).

18. The patterning method according to claim 17, wherein the composition for imprints comprises a polymerizable monomer (A), a photopolymerization initiator (B), and a lubricant (C).

19. The patterning method according to claim 17, wherein the composition for imprints comprises a resin component (D) and a lubricant (C).

20. A pattern produced by providing a composition for imprints onto a substrate to form a patterning layer thereon, and pressing a mold against a surface of the patterning layer,
wherein the composition for imprints comprises:
a lubricant (C), and
a polymerizable monomer (A) and a photopolymerization initiator (B) in combination, or a resin component (D).
